(19) United States
(12) Patent Application Publication
(10) Pub. No.: US 2025/0205915 A1
(43) Pub. Date: Jun. 26, 2025

(54) SLITTER HAVING SLITTER BODY AND DISC SEGMENTS

(71) Applicant: ISCAR, LTD., TEFEN (IL)

(72) Inventors: YARON EISEN, KFAR VRADIM (IL); ROOHI MOKTHAR, JULIS (IL)

(73) Assignee: ISCAR, LTD., TEFEN (IL)

(21) Appl. No.: 18/930,915

(22) Filed: Oct. 29, 2024

Related U.S. Application Data
(60) Provisional application No. 63/614,738, filed on Dec. 26, 2023.

(51) Int. Cl. B26D 1/00; B26D 7/26

(52) U.S. Cl. CPC B26D 1/0006; B26D 7/2614; B26D 2001/0033; B26D 2001/0053; B26D 2001/006

(57) ABSTRACT

A slitter having a slitter body and a plurality of disc segments mounted to pockets formed in the slitter body. The disc segments each have a plurality of integrally formed teeth. The slitter has a smoothly curved peripheral surface against which the disc segments abut when mounted thereto.

### RELATED APPLICATIONS

Priority is claimed to U.S. Provisional Patent Application No. 63/614,738, filed Dec. 26, 2023. The contents of the aforementioned application are incorporated by references in their entirety.

### FIELD OF THE INVENTION

The subject matter of the present application relates to a slitter having a slitter body and also disc segments configured to be mounted to the slitter body.

### BACKGROUND OF THE INVENTION

A slitter is designed to provide slits or grooves in a workpiece. For conciseness, the slits or grooves will be called “slits”, herein. Typically, the slitter's design is optimized to allow as deep a slit as possible, often allowing a depth of cut until a central shank is reached.

Integrally (or stated alternatively, “monolithically”, with both words meaning the same thing for the purposes of the specification and the claims) formed slitters (i.e., single-piece slitters, or, stated differently, discs with integral teeth) are common due to their many advantages. Since a thin cut width (CW) is typically desired, integrally slitters, typically made of steel, are often preferred because removable inserts and components for them (screws, insert pockets), necessitate a wider slitter and consequently either a larger cut width or a limited depth of cut if only the cutting edges of the inserts enter the workpiece. Similarly, integral slitters also advantageously can have a higher number of teeth since the teeth do not need external components or pocket constructions to hold them in place. Finally integral slitters provide superb precision, since all teeth are produced together and on a single component.

Slitters made of cemented carbide are alternatives to steel, due to improved machining capability, but unlike steel slitters are typically more limited in diameter due to their need to be pressed. Additionally, steel components can be produced thinner than large diameter cemented carbide components.

Additionally, cemented carbide components need to be sintered and typically ground to reach desired precision for machining.

The most notable drawback of integral slitters is that damage to a single tooth can result in the need to replace the entire slitter. This drawback is overcome by the use of non-integral cutting inserts or disc segments to a slitter body, so that when damage occurs an entire slitter does not need to be replaced. While such solution can overcome this issue, the drawbacks of multi-component slitters are listed above, namely they are thicker, less precise, result in a lower number of total cutting edges per slitter and are less user friendly to handle (requiring further assembly). Nonetheless, they are not limited by diameter in comparison with integral cemented carbide slitters.

U.S. Pat. No. 9,475,132 discloses an indexable insert design. This publication is of interest due to each side of the cutting insert having more than one tooth and a locating means (for example identified by numeral “152”), to assist in positioning. It will be noted that the drawings do not show a slitter designed to produce a slit, but rather a facing tool (i.e., machining not only in the radial direction but also in the forward axial direction). It will be understood that due to the indexability of the inserts shown, even if used in a slitter body (not shown) non-operative cutting edges of the inserts would prevent the shown tool's use as a slitter, at least for a significant depth of cut.

U.S. Pat. No. 5,209,611 discloses many different embodiments of indexable cutting inserts mounted to rotary tools. Referring to FIGS. 17 and 18, it is shown that an indexable insert can have two differently spaced cutting edges active along a periphery of a tool shown. Notable embodiments are shown on pages 4 and 5. Referring to one described example, to paraphrase, it is stated that the oblong shaped inserts 190 have “normal” surfaces 193 and 194. The various inserts having a “step” shape which is used to abut the insert to a peripheral surface of the disc-shaped body is what is considered to be a disc segment according to the present application rather than a cutting insert designed to be mounted to a pocket with only a slightly projecting cutting edge extending from the disc-shaped body. In other words, a disc segment is defined herein as a component configured to abut a peripheral surface of a disc-shaped tool body. Notably, the disc-shaped tool body has chamfered areas to accommodate the inserts or what is called in this application disc segments.

It is an object of the present application to provide a new and improved slitter, slitter body and disc segment.

### SUMMARY OF THE INVENTION

In accordance with a first aspect of the subject matter of the present application, there is provided a disc segment comprising: a segment first side surface; a segment second side surface; and a segment peripheral surface connecting the first side surface and the second side surface; the segment peripheral surface comprising: a segment cutting side; a segment rear side oppositely located to the segment cutting side; a segment top side extending between the segment cutting side and the segment rear side; and a segment bottom side extending between the segment cutting side and the segment rear side; the segment first side surface is formed with a segment step; the segment step comprising: a segment first sub-surface located opposite the segment cutting side; a segment second sub-surface oppositely located to the segment second side surface and facing the segment; and a segment corner extending along an intersection of the segment first sub-surface and the segment second sub-surface; a segment first sideways direction is defined from the segment second sub-surface towards the segment second side surface; a segment second sideways direction is defined opposite the segment first sideways direction; a segment radially outward direction is defined from the segment first sub-surface towards the segment cutting side; a segment radially inward direction is defined opposite to the segment radially outward direction; the segment cutting side comprising a plurality of teeth and a plurality of gullets, and between each pair of adjacent teeth is one of said gullets; each of the plurality of teeth comprising: a rake surface facing more towards the top side than the bottom side; a relief surface; a cutting edge formed at an intersection of the rake surface and the relief surface; each cutting edge comprising a forwardmost sub-edge extending more in the segment radially outward direction than the remainder of the cutting edge; wherein: the forwardmost sub-edges lie along a first imaginary arc; the segment first sub-surface comprises a segment first abutment surface and a segment second abutment surface located along a second imaginary arc; and the first imaginary arc and the second imaginary arc, when extended to form imaginary circles are concentric.

As will become clear when considering the entire slitter, the segment first abutment surface and segment second abutment surface lying on an imaginary arc, enable the disc segment to abut against a slitter body's precision, circular slitter peripheral edge.

To elaborate, the segment first abutment surface and the segment second abutment surface could be non-projecting spaced-apart parts of the segment first sub-surface (i.e., just part of an arced segment first sub-surface) which may be smoothly-curved and arc-shaped. Alternatively, as shown in the drawings the segment first sub-surface can further comprise a first abutment projection and a second abutment projection, wherein the first abutment projection comprises said segment first abutment surface, and the second abutment projection comprises said segment second abutment surface. In the latter option (abutment projections) itself the remainder of the segment first sub-surface itself is not necessarily arc-shaped.

Regardless of the possibilities above, it will be understood that the segment first sub-surface is not in any option, in its entirety, planar, at least according to the present aspect, since it is intended to securely abut a precisely produced, curved slitter peripheral surface (and contact of a single point of that curved surface would be unstable). This is notably different to U.S. Pat. No. 5,209,611 which discloses planar abutment surfaces along the slitter body peripheral surface, and segments formed with matching planar (“normal”) abutment surfaces, as mentioned above.

Abutment projections can be used to ensure the first abutment projection and the second abutment projection, and hence the segment first and second abutment surfaces, are spaced-apart at distal ends of the segment to increase stability. Stated differently, the segment first abutment surface may be distally located from the segment second abutment surface. Still in other words, the segment first abutment surface may be located adjacent the segment top side and the segment second abutment surface is located adjacent the segment bottom side. It is noted that the segment first abutment surface and a segment second abutment surface may be non-parallel planar surfaces. However, it will be understood that non-planar surfaces are also possible, for example, convex abutment surfaces.

Aside from the advantages above numerous benefits are possible with the disc segment of the present invention.

For example, during development an advantageous production method was utilized. Cutting inserts and disc segments are almost universally designed with planar abutment surfaces due to manufacturing considerations. This is because cemented carbide components are sintered (leaving a degree of imprecision after sintering). The high precision required by modern metal machining typically requires the sintered part to be ground to ensure acceptable size tolerances.

As the present disc segments may be made of cemented carbide, one would typically grind the cutting edges as well as the abutment surfaces. It will be understood that it is possible that disc segments may have an advantageous geometry could also be made of other materials, for example metal or ceramic.

To reduce the expensive grinding process of the disc segments (in addition simplifying production of a slitter body having a precision circular peripheral surface), it was theorized, and indeed found in practice, that precision cutting edges could be ground with the disc segments mounted on a slitter body having a circular peripheral edge, and the grinding of the cutting edges when the segment is mounted on a body simulating a future slitter body, would correct for the inaccuracies of the segment's abutment surfaces.

During development, the segments were designed to be placed as closely as possible to each other to prevent chips becoming jammed between the segments.

One feature to achieve this, is that each of the segment top side and the segment bottom side, adjacent to a respective closest tooth thereof, is planar. Thus in a sideways view, the disc segments can be placed close together. An entirety of each of the segment top side and the segment bottom side may be planar. Of course, it is feasible to curve the segment shape (for example for a segment top side being convex and a segment bottom side being concave) to achieve a similar dense packing of segments. However for production simplicity, a planar shape may be preferred.

Similarly, to avoid chips being jammed between disc segments, it was found beneficial for the disc segment to comprise a top gullet having a concave shape and formed above an uppermost tooth of the plurality of teeth. Thus as a chip is formed by the top tooth it not only does not enter a gap thereabove with the adjacent disc segment but it curls against the top tooth's own disc segment. To ensure the chip does not enter the gap, at an intersection of the segment top side and the concave gullet, the top gullet comprises a gullet projection which extends in the segment radially outward direction.

To achieve the benefit of a high number of teeth, the number N of said teeth is three or more. In difference to the indexable inserts of the prior art, the more teeth on a non-indexable disc segment reduces the overall cost. The number N of said teeth may fulfill the condition: 4≤N≤8. It will be understood that while increasing the number of teeth reduces production costs and assists high precision, a larger number of teeth increases the risk of production errors. It will be understood that adding teeth to an indexable insert increases the size of the insert significantly more, making it more expensive and less versatile (especially in the present case where the teeth may have a staggered arrangement, stated differently alternating slanted orientations).

Thus, it will be understood that there may be a preference for a larger number of teeth and a greater depth of cut rather than an indexable arrangement. In other words, the disc segment according to the present invention may have a single cutting portion (extending in the segment radially outward direction from segment first sub-surface) and a single mounting portion (extending in the segment radially inward direction from segment first sub-surface and including the segment first sub-surface).

Consecutive adjacent teeth of the plurality of teeth may be slanted relative to each other.

A unique mounting arrangement was developed. The disc segment may comprise a segment hook. While the segment hook allows the disc segment to align on a slitter body's smooth peripheral surface (i.e., the smooth slitter peripheral surface having no projections to anchor the disc segment), such segment hook is conceivably beneficial even if the disc segment and slitter body are not designed with the above mentioned arced abutment surfaces. Such design contributes to being able to provide a compact slitter (with many closely packed teeth on a single segment body). This is in contradistinction to the inserts of the prior art which require pocket walls for support and are consequently less densely packed.

The segment hook may be located closer to the segment top side than to the segment bottom side and the segment hook comprises a segment hook end extending in a segment radially inward direction and more towards the bottom side than the segment top side. Thus, even without further means the disc segment will naturally abut a circular slitter body during machining. The rigid segment hook absorbing the machining forces, as well as abutment with the slitter body's peripheral surface, rather than any other component such as a screw.

The segment hook may comprise a segment hook abutment surface facing the segment radially outward direction and being slanted more towards the segment bottom side than the segment top side.

The disc segments may comprise a single segment screw hole. It will be appreciated that replacing multiple disc segments of a slitter can be time consuming. Therefore, a single screw hole only (for a screw to provide a sideway biasing force) may be considered beneficial.

For embodiments with the above-described segment hook, the screw hole is only used for sideways abutment, with all of the machining forces being applied on the segment hook, segment first abutment surface and segment second abutment surface. Accordingly, the segment screw hole is located closer to the segment bottom side than to the segment top side so that the cutting forces can be absorbed by an integral segment hook.

In accordance with another aspect of the present invention there is provided a slitter body comprising: a slitter first side surface; a slitter second side surface; a slitter axis AS extending through the center of and perpendicular to the slitter first surface and the slitter second surface; and a slitter peripheral surface connecting the slitter first side surface and the slitter second side surface; a slitter first sideways direction is defined from the slitter first surface towards the slitter second surface; a slitter second sideways direction is defined opposite the slitter first sideways direction; a slitter radially outward direction is defined perpendicular to the slitter axis AS and extending outwardly therefrom; a slitter radially inward direction is defined opposite to the slitter radially outward direction; a slitter rotational cutting direction is defined about the slitter axis AS; a slitter rotational anti-cutting direction is defined as being in an opposite direction to the slitter rotational cutting direction; the slitter first side surface is formed with a plurality of pockets; each of the pockets comprise: a slitter first sub-surface facing the slitter radially outward direction; a slitter second sub-surface oppositely located to the slitter second side surface; and a slitter corner extending along an intersection of the slitter first sub-surface and the slitter second sub-surface; wherein: the slitter peripheral surface located in the slitter radially outward direction from each pocket has a smoothly-curved arc-shaped.

The entire slitter peripheral surface may have a smoothly-curved circular-shape.

The slitter peripheral surface has a curvature may correspond to the second imaginary arc.

Each of the pockets may comprise a pocket hook. Each of the pocket hooks may comprise a pocket hook abutment surface facing the slitter radially inward direction and being slanted more towards the slitter rotational cutting direction than the slitter rotational anti-cutting direction.

Each of the pockets may comprise a single threaded pocket screw hole.

It will be understood that the benefits mentioned above in connection with the disc segment, apply also to the slitter body above, designed to have the disc segments mounted thereto.

Additionally, for stable mounting, each of the pocket's slitter second sub-surfaces may comprise three pocket projections located at distal parts of the respective pocket.

The slitter body may be made of metal, e.g., steel.

The slitter body may comprise pockets on one side only (e.g., the slitter first side surface). This simplifies production and eases replacement of the disc segments.

In accordance with another aspect of the present invention there is provided a slitter comprising: a slitter body according to the above slitter aspect; a plurality of disc segments according to the above disc segment aspect; each of the disc segments being mounted in a respective pocket of the slitter body; wherein the segment second sub-surface abuts the slitter second sub-surface; wherein the segment first abutment surface and the segment second abutment surface contacts the smoothly-curved arc-shaped slitter peripheral surface located in the radially outward direction from the pocket in which it is mounted.

An index angle between all adjacent teeth of the slitter may be equal. It will be understood that this is a tightly packet tooth arrangement, and allows ease of manufacture with all segments being able to be produced on a dummy slitter body in a single mounting.

A cut width (CW) of the teeth of the slitter may be larger than a maximum slitter width (SW) of the slitter body, measured between the teeth and the slitter first sub-surface.

While the slitter, slitter body and disc segments above share common features for mounting of the disc segments on a smooth arc slitter peripheral surface, an independently inventive aspect is the provision of said top gullet to prevent chips jamming between adjacent disc segments.

Accordingly, another aspect of the present invention is the provision of a disc segment comprising, in combination: a segment first side surface; a segment second side surface; and a segment peripheral surface connecting the first side surface and the second side surface; the segment peripheral surface comprising: a segment cutting side; a segment rear side oppositely located to the segment cutting side; a segment top side extending between the segment cutting side and the segment rear side; and a segment bottom side extending between the segment cutting side and the segment rear side; the segment first side surface is formed with a segment step; the segment step comprising: a segment first sub-surface located opposite the segment cutting side; a segment second sub-surface oppositely located to the segment second side surface and facing the segment; and a segment corner extending along an intersection of the segment first sub-surface and the segment second sub-surface; a segment first sideways direction is defined from the segment second sub-surface towards the segment second side surface; a segment second sideways direction is defined opposite the segment first sideways direction; a segment radially outward direction is defined from the segment first sub-surface towards the segment cutting side; a segment radially inward direction is defined opposite to the segment radially outward direction; the segment cutting side comprising a plurality of teeth and a plurality of gullets, and between each pair of adjacent teeth is one of said gullets; each of the plurality of teeth comprising: a rake surface facing more towards the top side than the bottom side; a relief surface; a cutting edge formed at an intersection of the rake surface and the relief surface; each cutting edge comprising a forwardmost sub-edge extending more in the segment radially outward direction than the remainder of the cutting edge; wherein the disc segment further comprises a top gullet having a concave shape and formed above an uppermost tooth of the plurality of teeth.

The disc segment can have any one or a combination of the features stated above.

While the slitter, slitter body and disc segments above share common features for mounting of the disc segments on a smooth arc slitter peripheral surface, an independently inventive aspect is the provision of a segment hook on a disc segment as described above, and a slitter body (and consequently slitter) configured for mounting of the disc segment thereon.

Accordingly, another aspect of the present invention is the provision of a disc segment comprising, in combination: a segment first side surface; a segment second side surface; and a segment peripheral surface connecting the first side surface and the second side surface; the segment peripheral surface comprising: a segment cutting side; a segment rear side oppositely located to the segment cutting side; a segment top side extending between the segment cutting side and the segment rear side; and a segment bottom side extending between the segment cutting side and the segment rear side; the segment first side surface is formed with a segment step; the segment step comprising: a segment first sub-surface located opposite the segment cutting side; a segment second sub-surface oppositely located to the segment second side surface and facing the segment; and a segment corner extending along an intersection of the segment first sub-surface and the segment second sub-surface; a segment first sideways direction is defined from the segment second sub-surface towards the segment second side surface; a segment second sideways direction is defined opposite the segment first sideways direction; a segment radially outward direction is defined from the segment first sub-surface towards the segment cutting side; a segment radially inward direction is defined opposite to the segment radially outward direction; the segment cutting side comprising a plurality of teeth and a plurality of gullets, and between each pair of adjacent teeth is one of said gullets; each of the plurality of teeth comprising: a rake surface facing more towards the top side than the bottom side; a relief surface; a cutting edge formed at an intersection of the rake surface and the relief surface; each cutting edge comprising a forwardmost sub-edge extending more in the segment radially outward direction than the remainder of the cutting edge; wherein the disc segment comprises a segment hook.

The disc segment can have any one or a combination of the features stated above.

Accordingly, another aspect of the present invention is the provision of a slitter body comprising: a slitter first side surface; a slitter second side surface; a slitter axis AS extending through the center of and perpendicular to the slitter first surface and the slitter second surface; and a slitter peripheral surface connecting the slitter first side surface and the slitter second side surface; a slitter first sideways direction is defined from the slitter first surface towards the slitter second surface; a slitter second sideways direction is defined opposite the slitter first sideways direction; a slitter radially outward direction is defined perpendicular to the slitter axis AS and extending outwardly therefrom; a slitter radially inward direction is defined opposite to the slitter radially outward direction; a slitter rotational cutting direction is defined about the slitter axis AS; a slitter rotational anti-cutting direction is defined as being in an opposite direction to the slitter rotational cutting direction; the slitter first side surface is formed with a plurality of pockets; each of the pockets comprise: a slitter first sub-surface facing the slitter radially outward direction; a slitter second sub-surface oppositely located to the slitter second side surface; and a slitter corner extending along an intersection of the slitter first sub-surface and the slitter second sub-surface; wherein each of the pockets comprise a pocket hook.

The slitter body can have any one or a combination of the features stated above.

Accordingly, another aspect of the present invention is the provision of a slitter comprising a slitter body and a disc segment according to the previous two aspects.

### BRIEF DESCRIPTION OF THE DRAWINGS

For a better understanding of the subject matter of the present application, and to show how the same may be carried out in practice, reference will now be made to the accompanying drawings, in which:

FIG. 1A is a perspective view of a slitter according to the present invention;

FIG. 1B is another perspective view of the slitter in FIG. 1A;

FIG. 1C is a top view of the slitter in FIG. 1A;

FIG. 1D is a side view of the slitter in FIG. 1A;

FIG. 2A is perspective view of a disc segment of the slitter in FIG. 1A;

FIG. 2B is another perspective view of the disc segment in FIG. 2A;

FIG. 2C is a rear view of the disc segment in FIG. 2A;

FIG. 2D is a first side view of the disc segment in FIG. 2A;

FIG. 2E is a bottom view of the disc segment in FIG. 2A;

FIG. 2F is a second side view of the disc segment in FIG. 2A;

FIG. 2G is a top view of the disc segment in FIG. 2A;

FIG. 3A is a top view of a slitter body of the slitter in FIG. 1A;

FIG. 3B is a side view of the slitter body in FIG. 3A;

FIG. 3C is an enlarged view of a portion of the slitter body in FIG. 3B;

FIG. 3D is an enlarged view of a portion of the slitter body in FIG. 3A;

FIG. 3E is a perspective view of the portion of the slitter body in FIG. 3D;

FIG. 4A is perspective view of a screw of the slitter in FIG. 1A;

FIG. 4B is a side view of the screw in FIG. 4A; and

FIG. 4C is a top view of the screw in FIG. 4A.

### DETAILED DESCRIPTION

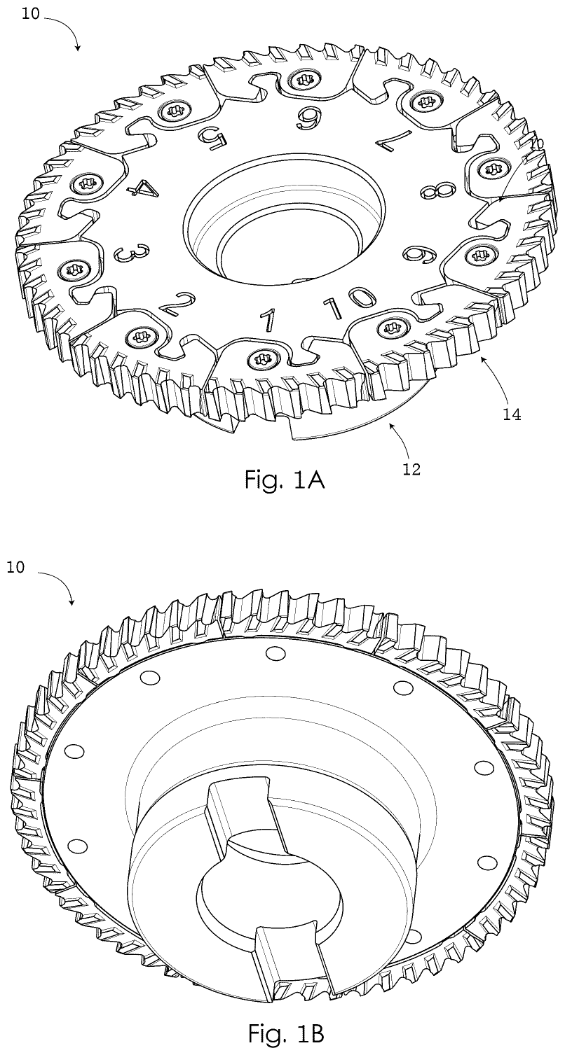

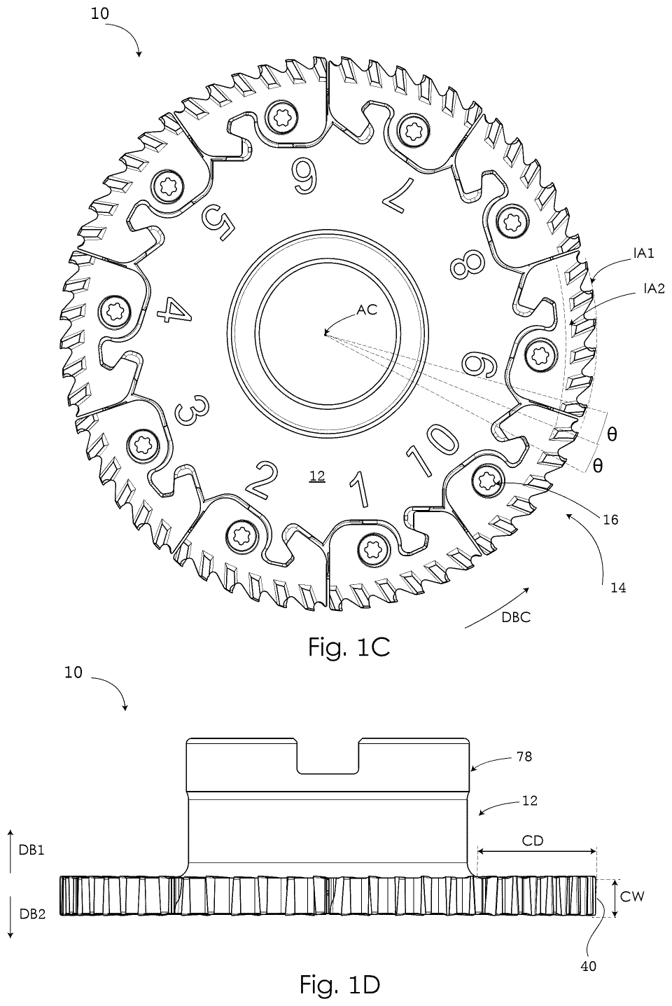

Reference is made to FIGS. 1A to 1D which illustrate an example slitter 10 having a central axis AC and comprising a slitter body 12 and a plurality of disc segments 14 mounted to the slitter body 12. Each of the disc segments 14 is secured with a single screw 16.

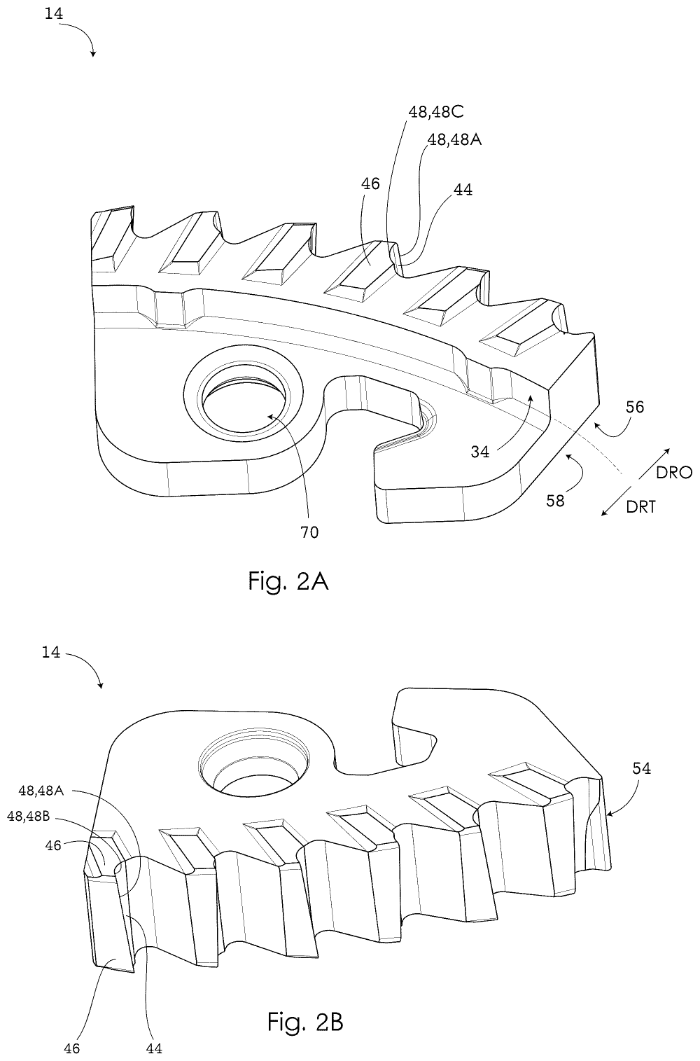

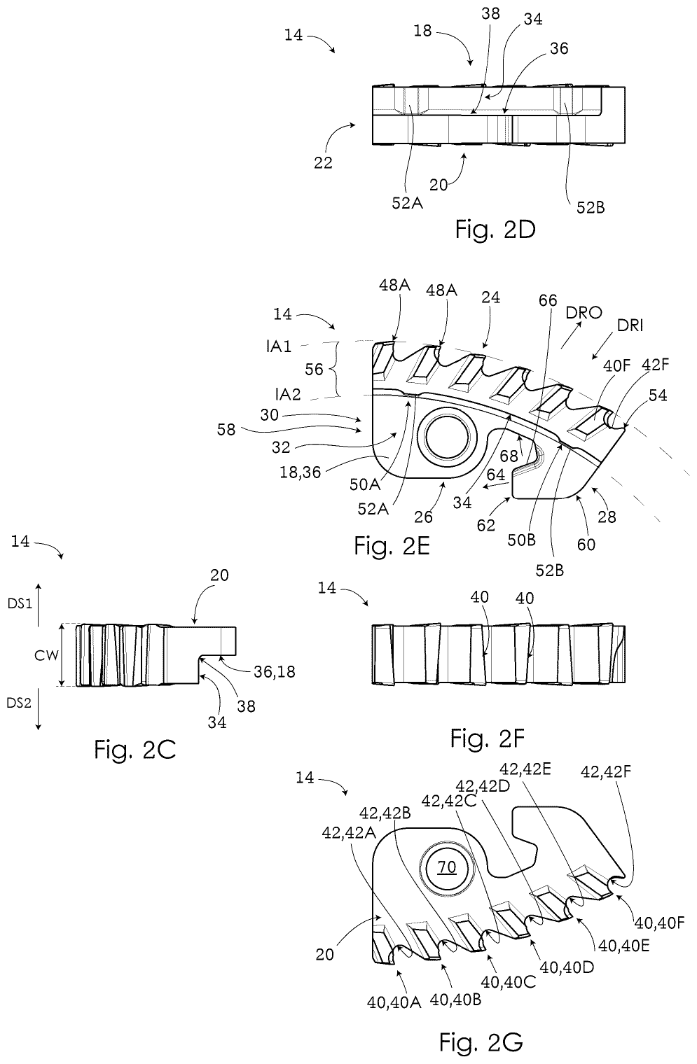

Drawing attention to FIGS. 2A to 2G, each disc segment 14 comprises a segment first side surface 18, a segment second side surface 20 and a segment peripheral surface 22.

The segment peripheral surface 22 comprises a segment cutting side 24, a segment rear side 26, a segment top side 28, and a segment bottom side 30.

The segment first side surface 18 is formed with a segment step 32 comprising a segment first sub-surface 34, a segment second sub-surface 36, and a segment corner 38.

A segment first sideways direction DS1 is defined from the segment second sub-surface 36 towards the segment second side surface 20.

A segment second sideways direction DS2 is defined opposite the segment first sideways direction DS1.

A segment radially outward direction DRO is defined from the segment first sub-surface 34 towards the segment cutting side 24.

A segment radially inward direction DRI is defined opposite to the segment radially outward direction DRO.

The segment cutting side 24 comprises a plurality of teeth 40 (specifically a first tooth 40A, second tooth 40B, third tooth 40C, fourth tooth 40D, fifth tooth 40E and sixth tooth 40F, the sixth tooth 40F also being a so-called “uppermost tooth”) and a plurality of gullets 42 (specifically a first gullet 42A, second gullet 42B, third gullet 42C, fourth gullet 42D, fifth gullet 42E and sixth gullet 42F, the sixth gullet 42F also being a so-called “top gullet”).

Each of the plurality of teeth 42 comprises a rake surface 44, a relief surface 46, and a cutting edge 48.

Each cutting edge 48 comprises a forwardmost sub-edge 48A extending more in the segment radially outward direction than the remainder of the cutting edge 48, a first side sub-edge 48B and a second side sub-edge 48C.

The forwardmost sub-edges 48A lie along a first imaginary arc IA1. Even though only two forwardmost sub-edges 48A are identified with a character reference, it will be understood that all of the forwardmost sub-edges 48A of all of the six teeth 48 lie along the first imaginary arc IA1.

Measuring the cutting edges 48 parallel to the segment first sideways direction DS1 and second sideways direction DS2 gives a cut width CW of the teeth 40.

The segment first sub-surface 34 comprises a first abutment projection 50A and a second abutment projection 50B. The first abutment projection 50A comprises a segment first abutment surface 52A, and the second abutment projection 50B comprises a segment second abutment surface 52B.

The segment first abutment surface 52A and the segment second abutment surface 52B are planar. However, in some embodiments, the segment first abutment surface 52A and the segment second abutment surface 52B may be convex abutment surfaces. The segment first abutment surface 52A and the segment second abutment surface 52B lie along a second imaginary arc IA2.

Referring briefly also to FIG. 1C, the first imaginary arc IA1 and the second imaginary arc IA2 are concentric. In other words, if the first and second arcs would be extended to form imaginary circles, they would be concentric (i.e., have a common center). In the present example, the common center is shown in a side view, i.e., FIG. 1C, and is the central axis AC.

Reverting to FIG. 2E, the top gullet 42F has a concave shape and comprises a gullet projection 54 which extends in the segment radially outward direction.

Referring to FIG. 2A, the disc segment 14 comprises a single cutting portion 56 extending in the segment radially outward direction DRO from segment first sub-surface 34 and a single mounting portion 58 extending in the segment radially inward direction DRI from segment first sub-surface 34 and including the segment first sub-surface 34.

As shown, for example, in FIG. 2F consecutive adjacent teeth of the plurality of teeth 40 are slanted relative to each other.

The disc segment 14, or stated alternatively the mounting portion 58, comprises a segment hook 60 comprising a segment hook end 62 which extends in the segment radially inward direction DRI and more towards the bottom side 30 than the segment top side 28. For clarity, this direction is denoted with an arrow with the reference numeral “64”.

When it is said that a direction is more towards a certain surface, it is meant that in that exact direction towards that certain surface (and the opposing surface being in the exact opposite direction) the meant direction is the exact direction within 90 degrees of either side (±90° but not including exactly 90°).

The segment hook 62 comprises a segment hook abutment surface 66 facing the segment radially outward direction DRO and being slanted more towards the segment bottom side 30 than the segment top side 28. For clarity, this direction is denoted with an arrow with the reference numeral “68”.

Each disc segment 14 comprises a single segment screw hole 70.

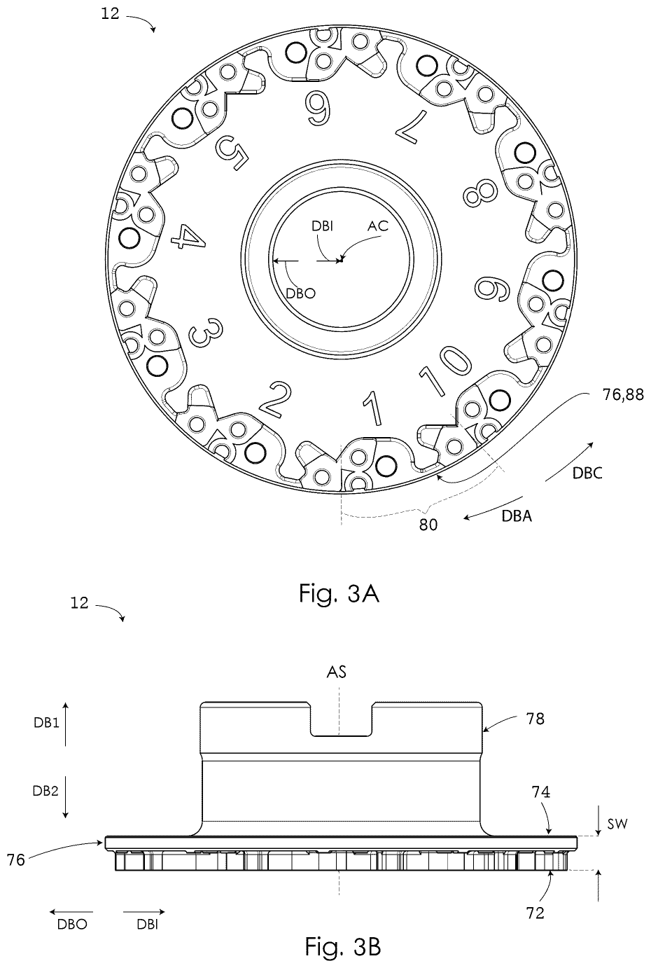

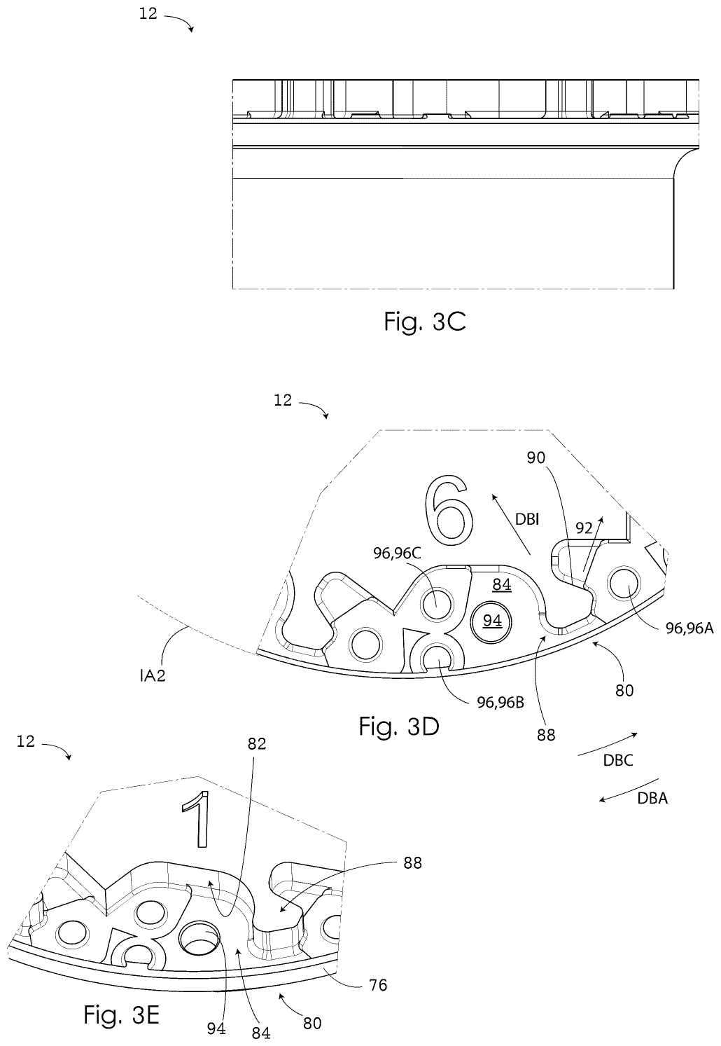

Referring now to FIGS. 3A to 3E, the slitter body 12 comprises a slitter first side surface 72, a slitter second side surface 74, a slitter axis AS, and a slitter peripheral surface 76.

The slitter body 12 may be monolithically formed with a slitter shank 78 extending from the slitter second side surface 74 and coaxial with the slitter axis AS. It will be understood that a known option is for a slitter body (not shown) to be configured to be attached to a shank (not shown), e.g., with screws.

A slitter first sideways direction DB1 is defined from the slitter first surface 72 towards the slitter second surface 74.

A slitter second sideways direction DB2 is defined opposite the slitter first sideways direction DB1.

A slitter radially outward direction DBO is defined perpendicular to the slitter axis AS and extending outwardly therefrom.

A slitter radially inward direction DBI is defined opposite to the slitter radially outward direction DBO.

A slitter rotational cutting direction DBC is defined about the slitter axis AS.

A slitter rotational anti-cutting direction DBA is defined as being in an opposite direction to the slitter rotational cutting direction DBC.

Excluding the slitter shank 78, measuring the slitter body 12 from the slitter first side surface 72 and second side surface 74 gives a maximum slitter width SW of the slitter body 12.

The slitter first side surface 72 is formed with a plurality of pockets 80.

Each pocket 80 comprises a slitter first sub-surface 82 facing the slitter radially outward direction DBO, a slitter second sub-surface 84 and a slitter corner 86.

Referring to FIG. 3A, the slitter peripheral surface 76 located in the slitter radially outward direction DBO from each pocket 80 (for convenience identified with the numeral 80) has a smoothly-curved arc-shaped. It will be understood that only the portion of the slitter peripheral surface 76 which must be smooth is where the disc segment 14 abuts it, and in other areas could have, for example projections or cavities. However, it may be preferred for ease of manufacture and efficiency that the entire slitter peripheral surface 76 has a smoothly-curved circular-shape as shown.

The slitter peripheral surface 76 also has the same curvature as the second imaginary arc IA2.

Each of the pockets 80 comprise a pocket hook 88 comprising a pocket hook abutment surface 90 facing the slitter radially inward direction DBI and being slanted more towards the slitter rotational cutting direction DBC than the slitter rotational anti-cutting direction DBA. For clarity, this direction is denoted with an arrow with the reference numeral “92”.

Each of the pockets 80 comprise a single threaded pocket screw hole 94.

Each slitter second sub-surface 84 comprises three pocket projections 96 (specifically a first pocket projection 96A, second pocket projection 96B and third pocket projection 96C) located at distal parts of the respective pocket 80.

More precisely, the first pocket projection 96A is furthermost in the slitter rotational cutting direction DBC, and may be even further in that direction than the pocket hook 88. By contrast, the second pocket projection 96B and third pocket projection 96C are equally distal in the slitter rotational anti-cutting direction DBA, and are even further in that direction than the pocket screw hole 94. The distal locations of the pocket projections 96 are to improve stability as is the triangular formation they provide.

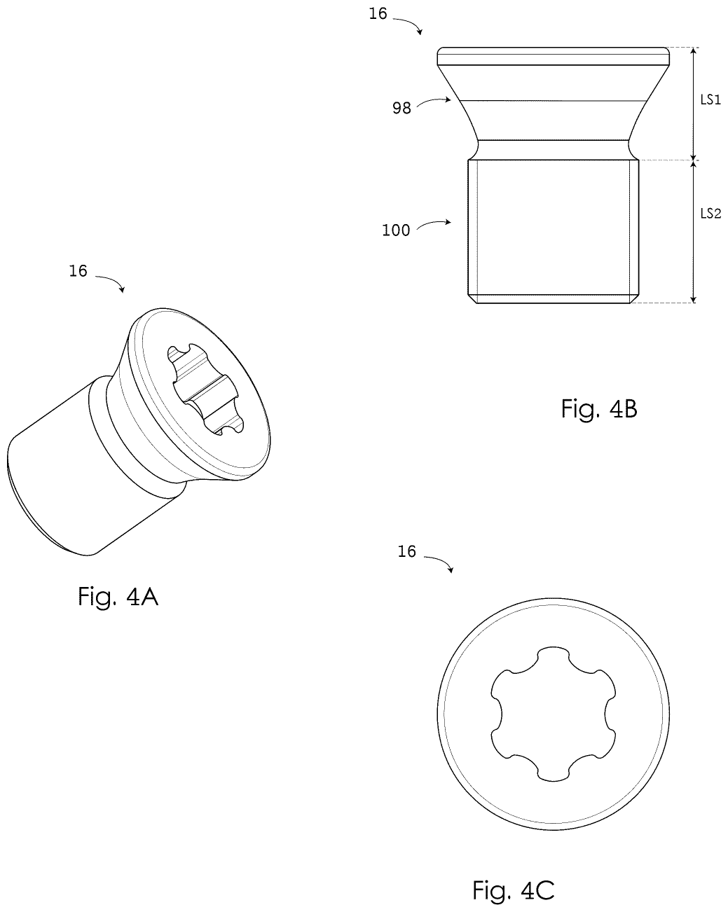

Referring to FIGS. 4A to 4C, the screw 16 comprises a screw head 98 and a screw shank 100.

The screw head 98 has a screw head length LS1.

The screw shank 100 has a screw shank length LS2.

Advantageously, the screw shank 100 has been made shorter than a standard screw to allow it to not project from the assembled slitter, such that the cut width CW is larger than any projection of the screw 16 in either of the slitter first sideways direction DB1 and the slitter second sideways direction DB2.

Regarding assembly, notably, the slitter first sub-surface 82 does not contact the disc segment 14.

When assembled: the screw shank 100 is threaded to the pocket screw hole 94 with the screw head 98 abutting the segment screw hole 70 which in turn biases the segment second sub-surface 36 into abutment with the slitter second sub-surface 84 (or more precisely biases the segment second sub-surface 36 into abutment with the three pocket projections 96 of the slitter second sub-surface 84); the segment first abutment surface 52A and the segment second abutment surface 52B abut the smoothly-curved arc-shaped slitter peripheral surface 76; and the segment hook abutment surface 66 abuts the pocket hook abutment surface 90. The position of the pocket screw hole 94 and the segment screw hole 70 may be arranged to slightly bias the disc segment 14 in the slitter rotational anti-cutting direction DBA and the slitter radially inward direction DBI to bring all of the abutments mentioned above into contact.

Reverting to FIG. 1C, there are 60 teeth in the 360 degree construction. Thus, the index angle θ between all adjacent teeth 40 of the slitter 10 is equal and in this example is 6 degrees. Drawing attention to FIG. 1D, as can be understood from the fact that the slitter body 12 (except the slitter shank 78) cannot be seen in the side view of FIG. 1D, the cut width CW of the teeth 40 of the slitter 10 is larger than a maximum slitter width SW of the slitter body 12. Thus, in this example the slitter 10 is able to form a slit with a cut depth CD, i.e., up to the slitter shank.

What is claimed is:

1. A disc segment comprising:
a segment first side surface;
a segment second side surface; and
a segment peripheral surface connecting the first side surface and the second side surface;
the segment peripheral surface comprising:
a segment cutting side;
a segment rear side oppositely located to the segment cutting side;
a segment top side extending between the segment cutting side and the segment rear side; and
a segment bottom side extending between the segment cutting side and the segment rear side;
the segment first side surface is formed with a segment step;
the segment step comprising:
a segment first sub-surface located opposite the segment cutting side;
a segment second sub-surface oppositely located to the segment second side surface and facing the segment; and
a segment corner extending along an intersection of the segment first sub-surface and the segment second sub-surface;
a segment first sideways direction defined from the segment second sub-surface towards the segment second side surface;
a segment second sideways direction defined opposite the segment first sideways direction;
a segment radially outward direction defined from the segment first sub-surface towards the segment cutting side;
a segment radially inward direction defined opposite to the segment radially outward direction;
the segment cutting side comprising a plurality of teeth and a plurality of gullets, and between each pair of adjacent teeth is one of said gullets;
each of the plurality of teeth comprising:
a rake surface facing more towards the top side than the bottom side;
a relief surface; and
a cutting edge formed at an intersection of the rake surface and the relief surface;
each cutting edge comprising a forwardmost sub-edge extending more in the segment radially outward direction than the remainder of the cutting edge;
wherein:
the forwardmost sub-edges lies along a first imaginary arc;
the segment first sub-surface comprises a segment first abutment surface and a segment second abutment surface is located along a second imaginary arc; and
the first imaginary arc and the second imaginary arc, when extended to form imaginary circles are concentric.

2. The disc segment as claimed in claim 1, wherein the segment first sub-surface further comprises a first abutment projection and a second abutment projection; the first abutment projection comprising said segment first abutment surface; the second abutment projection comprising said segment second abutment surface.

3. The disc segment as claimed in claim 1, wherein the segment first abutment surface and a segment second abutment surface are non-parallel planar surfaces.

4. The disc segment as claimed in claim 1, wherein the number N of said teeth fulfills the condition: 4≤N≤8.

5. The disc segment as claimed in claim 1, wherein each of the segment top side and the segment bottom side, adjacent to a respective closest tooth thereof, is planar.

6. The disc segment as claimed in claim 1, further comprising a top gullet having a concave shape and formed above an uppermost tooth of the plurality of teeth.

7. The disc segment as claimed in claim 6, wherein at an intersection of the segment top side and the concave gullet, the top gullet comprises a gullet projection which extends in the segment radially outward direction.

8. The disc segment as claimed in claim 1, further comprising a segment hook.

9. The disc segment as claimed in claim 8, wherein the segment hook is located closer to the segment top side than to the segment bottom side and the segment hook comprises a segment hook end extending in the segment radially inward direction and more towards the bottom side than the segment top side.

10. The disc segment as claimed in claim 9, wherein the segment hook further comprises a segment hook abutment surface facing the segment radially outward direction and being slanted more towards the segment bottom side than the segment top side.

11. The disc segment as claimed in claim 1, further comprising a single segment screw hole.

12. The disc segment as claimed in claim 1, wherein only the teeth of the disc segment is ground.

13. A slitter body comprising:
a slitter first side surface;
a slitter second side surface;
a slitter axis AS extending through the center of and perpendicular to the slitter first surface and the slitter second surface; and
a slitter peripheral surface connecting the slitter first side surface and the slitter second side surface;
a slitter first sideways direction defined from the slitter first surface towards the slitter second surface;
a slitter second sideways direction defined opposite the slitter first sideways direction;
a slitter radially outward direction defined perpendicular to the slitter axis AS and extending outwardly therefrom;
a slitter radially inward direction defined opposite to the slitter radially outward direction;
a slitter rotational cutting direction defined about the slitter axis AS;
a slitter rotational anti-cutting direction defined as being in an opposite direction to the slitter rotational cutting direction;
the slitter first side surface formed with a plurality of pockets;
each of the pockets comprise:
a slitter first sub-surface facing the slitter radially outward direction;
a slitter second sub-surface oppositely located to the slitter second side surface; and
a slitter corner extending along an intersection of the slitter first sub-surface and the slitter second sub-surface;
wherein the slitter peripheral surface is located in the slitter radially outward direction from each pocket has a smoothly-curved arc-shaped.

14. The slitter body as claimed in claim 13, wherein the entire slitter peripheral surface has a smoothly-curved circular-shape.

15. The slitter body as claimed in claim 13, wherein each of the pockets comprise a pocket hook.

16. The slitter body as claimed in claim 15, wherein each of the pocket hooks comprises a pocket hook abutment surface facing the slitter radially inward direction and being slanted more towards the slitter rotational cutting direction than the slitter rotational anti-cutting direction.

17. The slitter body as claimed in claim 13, wherein each of the pockets comprises a single threaded pocket screw hole.

18. The slitter body as claimed in claim 13, wherein each of the pocket's slitter second sub-surfaces comprises three pocket projections located at distal parts of the respective pocket.

19. A slitter comprising:
a slitter body according to claim 13;
a plurality of disc segments according to claim 1, each of the disc segments being mounted in a respective pocket of the slitter body;
wherein the segment second sub-surface abuts the slitter second sub-surface; and
wherein the segment first abutment surface and the segment second abutment surface contacts the smoothly-curved arc-shaped slitter peripheral surface located in the radially outward direction from the pocket in which it is mounted.

20. The slitter as claimed in claim 19, wherein an index angle θ between all adjacent teeth of the slitter is equal.

21. The slitter as claimed in claim 20, wherein a cut width CW of the teeth of the slitter is larger than a maximum slitter width SW of the slitter body, measured between the teeth and the slitter first sub-surface.
